(19) United States
(12) Patent Application Publication
(10) Pub. No.: US 2024/0020875 A1
(43) Pub. Date: Jan. 18, 2024

(54) METHOD FOR DETERMINING A CAMERA POSE IN A MULTI-CAMERA SYSTEM, COMPUTER PROGRAM, MACHINE-READABLE MEDIUM AND CONTROL UNIT

(71) Applicant: Robert Bosch GmbH, Stuttgart (DE)

(72) Inventor: Mark den Hartog, VW Eindhoven (NL)

(21) Appl. No.: 18/255,255

(22) PCT Filed: Dec. 4, 2020
(86) PCT No.: PCT/EP2020/084682

§ 371 Date: May 31, 2023

(51) Int. Cl. G06T 7/73; H04N 23/90; G06T 7/292; H04N 7/18; G06T 7/80

(52) U.S. Cl. CPC G06T 7/73; H04N 23/90; G06T 7/292; H04N 7/181; G06T 7/80; G06T 2207/30244; G06T 2207/30241; G06T 2207/20084; G06T 2207/30232

(57) ABSTRACT

Method for determining a camera pose in a multicamera system, wherein the multicamera system comprises a first camera (2) with a first field of view (4) and a second camera (3) with a second field of view (5), wherein the first camera (2) and the second camera (3) are arranged without an overlap of the first field of view (4) and the second field of view (5), wherein first camera data are collected for a first event in the first field of view (4), wherein second camera data are collected for a second event in the second field of view (5), wherein the second event is a causal event induced by the first event, wherein a relative camera pose between the first camera (2) and the second camera (3) is determined based on the first camera data for the first event, the second camera data for the second event and at least one causal relation between the first event and the second event.

### BACKGROUND

Multi-camera systems with at least two cameras are widely used in different use cases. For example, they are used for surveillance, e.g., CCTV in public places, indoor or outdoor. In many applications the relative poses of the cameras in the multi-camera system are needed, for example for tracking the objects.

A general problem in computer vision is how to automatically estimate the poses of a camera relative to other camera. The well-established procedure for estimating the relative poses is based on assuming an overlap of their fields of view. Using the overlap of the fields of view and acquiring multiple pairs of images for both cameras at the same moment in time unique features in both images can be detected to calculate the relative poses.

However, the constraint of having direct line of sight between cameras in the multi-camera system, might not hold in practice, especially when limited camera devices are available, the line of sight is obstructed by the environment, for example inside buildings, or when privacy regulations create artificial blind spots.

The document DE 10 2017 221 721 A1, which seems to be the closest state of the art, describes a device for calibrating a multi-camera system in a vehicle. The device comprises a first and a second pattern, wherein the first and second pattern are connected by a solid rack. The solid rack and the device are configured to position the first and second pattern in the field of view of the two cameras.

### SUMMARY

According to the invention and method for determining a camera pose in a multi-camera system is proposed. Furthermore, the invention discloses a computer program, machine-readable medium and a control unit.

The invention concerns a method for determining at least one pose of a camera in a multi-camera system. The method is especially executable by a computer and/or implemented by a software. The method can be executed and/or run by the multi-camera system, the camera, a surveillance system or a central module. The multi-camera system is for example adapted as surveillance system. The multi-camera system is preferably configured for an object detection and/or object tracking, especially for indoor and/or outdoor surveillance. The method is adapted for determining the camera of one, two or more cameras of the multi-camera system. Determining is optionally understood as estimating or calculating the camera pose. Camera pose is preferably understood as a relative pose of one camera to another camera of the multi-camera system. Alternatively, camera pose is understood as the absolute pose of a camera in the multi-camera system.

The multi-camera system comprises a first camera and a second camera. Furthermore, the multi-camera system may comprise more than two cameras, for example more than 10 or more than 100 cameras. Especially, the multi-camera system may comprise sensors and/or microphones for taking measurements and/or surveillance using different information than images or videos. The first and second camera are preferably arranged in the surveillance area. The first and the second camera are especially arranged and/or mounted with a spatial distance. The first and/or the second camera is preferably stationary mounted and/or arranged, alternatively the camera is mobile e.g., using a robot. The first camera has a first field of view and the second camera has a second field of view. The cameras are configured to take pictures, videos and/or additional measurements in their field of view. The first and the second camera are arranged without an overlap of the first field of view and the second field of view. The method may also be used for a first camera and a second camera having an overlap of the first and the second field of view, whereby the method is nevertheless adapted for the use in multi-camera systems with camera having no overlap in their field of view.

The first camera data are collected, captured and/or taken for the first field of view. The first camera data are collected for a first event. The first event is an event in the first field of view. The first event preferably comprises a pattern, especially a unique pattern. The first event may comprise sub-events which are forming together the first event. Alternatively the first camera data are collected for several first events. The first event is for example adapted or based on a movable object, an optical event, a physical event, a mechanical event or chemical event, especially a mixture of different events. Event is preferably understood as a process, especially an ongoing or lasting process. The first camera data and the second camera data are for example adapted as images, a video stream or optical sensor data. The first and/or the second camera data may comprise at least one image, a video stream or sensor data for the first field of view or the second field of view. The second camera is collecting, capturing and/or taking second camera data. The second camera data are preferably adapted like the first camera data. The second camera data are collected, taken and/or captured for and/or in the second field of view. The second camera data are collected, taken and/or captured for a second event. The second event is preferably not identical to the first event. The second event may be a different type of event, especially a different pattern as the pattern of the first event. The second event may comprise sub-events or more than one second event is collected as second camera data. The first camera and especially the second camera event are preferably artificial events, for example generated for calibrating the multi-camera system. Alternatively, the first and/or second event may be a natural event.

The second event is a causal event which is induced by the first event and/or related to the first event. The second event is therefore related, preferably with knowing the causal relation, to the first event. This especially means, that the first event in the first field of view induces the second event in the second field of view. The causal relation and/or the inducing of the second event is for example based on a physical relation; mechanical relation, physical interaction, mechanical interaction or describable by a physical or analytical law. Especially, the first and the second event may occur at different times, for example the second event happens at a later time than the first event.

The camera pose of at least one camera of the multi-camera system, preferably the relative poses, is determined, estimated and/or calculated using the first camera data and the second camera data, especially using the causal relation of the first event and the second event. Especially, the relative pose between the first camera and the second camera is determined, calculated and/or estimated based on the first camera data, the first event, the second Camera data, the second event and/or the causal relation between the first and the second event. The causal relation is for example the physical or mechanical interaction, law and/or relation of first and second event.

The method is based on the idea that instead using an overlap of field of views in a multi-camera system one can use field of views having no overlap in their field of views and use instead the causal relation of two spatial distanced events. Collecting camera data for the first and second event in the spatial distanced field of views and knowing their causal relation the pose of the cameras and especially their geometrical relation can be calculated using the method.

Therefore, the method can be used for multi-camera systems having no overlap in their field of views but can also be used also for multi-camera systems having cameras with an overlap in their field of fuse. Furthermore, instead of using a fixed rack which is basically adapted to the special use case, for example using one pattern inside the car and one outside the car, the proposed method can be used for different multi-camera systems because no solid racks or geometrical assumptions are needed. Therefore, the method according to the invention is usable very flexible in different use cases and extensive surveillance areas. Also no errors can occur due to wrong handling of a user.

Preferably, based on the determined relative pose between the first camera and the second camera an absolute pose of the first camera and/or the second camera is determined. The absolute pose is for example the absolute poses in a world coordinate system, e.g., the surveillance area. Especially, the relative and/or absolute pose is determined in a three-dimensional coordinate system. Preferably, the absolute pose is determined in a cartesian coordinate system, which is especially based on a horizontal axis, vertical axis and a third axis which is perpendicular to the horizontal and vertical axis.

According to an embodiment of the method the pose, especially the absolute and/or relative pose, comprising a location and an orientation in space. The location is preferably a point in space, especially in three dimensions. The orientation in space is preferably given by three angles, e.g., euler angles.

The first event is preferably based or given by a moving object in the first field of view. Particularly, the wording “based on a moving object for the first event” can be understood as the first event comprises also another event or more connected events, like blinking lights on the moving object. The first camera data are comprising data, information and especially images of the object in the first field of view, especially for the movement of the object in the first field of view. The second event in this embodiment is based on the same object, which is moving during the first event in the first field of view, but resulting in an event in the second field of view. For example, the same object is in the second event moving in the second field of view, but at a different time, especially a later time. This for example happens when the moving object is at first moving in the first field of view and then moving to the second field a view and captured by the second camera as second camera data.

Preferably, the first camera data are analysed for detecting and/or tracking the moving object in the first event. Based on the first camera data a path, trajectory and/or its kinematic is determined. Particularly, the path, trajectory and/or kinematic is extrapolated. The moving object of the first event is searched and/or detected in the second field of view based on the second camera data. Especially, the moving object in the first and the second field of view is a unique object and/or distinguishable. For the detected moving object in the second field of view together with the extrapolated trajectory, path and/or kinematic of the object the camera pose, especially relative or absolute camera pose, is determined, estimated and/or calculated. For example, the moving object is detected and tracked in the first and the second field of view based on the first and the second camera data, wherein the trajectories, paths and/or kinematics are a determined in both fields of view, wherein the tracked moving object, especially their trajectories, paths and/or kinematics are linked, e.g., using the extrapolation, wherein using the linking the pose of the camera is determined.

In an optional embodiment the first event is based on a visible object in the first field of view. For example, the first event is based on a solid object, a furniture or a person which is located in the first field of view. The visible object can be a static or moving object. The second event is based on a shadowing of the visible object of the first event leading to shadow in the second field of view. Particularly, the visible object of the first event is in the second event not material located in the second field of view. Especially, the first event can be based on a moving visible object, wherein the second event is based on the shadowing of the visible object in the second field of view and a detection of the same visible object in the second field of view at a different time. The causal relation for the shadowing is for example given by the rules of optic and/or a knowledge of lightening conditions.

Optionally, the first event is based on a visible object in the first field of view, for example the visible object resulting in shadowing in the second field of view. In this embodiment the second event is based and/or comprises a reflection of the visible object in the second field of view, whereby the object is still located in the first field of view. The reflection is for example in a mirror, a window, a glass surface or metal surface. This embodiment is based on the idea that visible object as real object are detected by the first camera in the first field of view and the second event is only the reflection of this visible object in the second field of view.

Particularly, the first event is based on a visible object in the first field of view. The visible object has a lamp attached to it or the visible object is formed by the lamp. The lamp is configured to generate an illumination pattern, whereby the illumination pattern is for example a time, spectral, wavelength or intensity modulation. The second event is based on the illumination pattern detectable in the second field of view and caused by the lamp of the visible object in the first field of view. For example the first event is the detection of the visible object as object in the first field a view or the detection of the lighting pattern in the first field of view. The second event is for example only the detection of the illumination pattern in the second field of view generated by the lamp in the first field of view. The causal relation is especially the propagation of light produced by the lamp.

Preferably, the first event is based on a modulated light signal, for example produced by the lamp. The modulated light signal can be a modulation of the intensity, wavelengths, frequency, phase, polarization or amplitude. Especially, the modulated light signal is a directed, pointed, focused and/or orientated light signal. The second event is based on the modulated light signal detected with the second camera in the second field of view. Based on the first camera data and the second camera data the modulated light signal is detected and/or analysed in those field of view. Preferably, based on the first and the second camera data the amplitude or phase of the light signal is analysed and/or a determined. The pose, especially the relative or the absolute pose, is determined based on the analysis of the modulated light, especially based on the determined amplitude and/or phase of the light signal.

Additionally or alternatively, the method uses a first event and second event that are based on a modulated sound signal. Especially, the method using the modulated sound signal is based on similar principles as using the modulated light signal. The sound signal is captured by the first camera in the first field of view and captured by the second camera in the second field of view. For example, the first and the second camera comprise a microphone or sound sensor. The first and the second camera data are comprising the captured sound signal. The first and second camera data are analysed, for example for determining the phase and/or amplitude of the sound signal. Based on the analysis of the sound signal in the first and second camera data, especially the determined phase and/or amplitude of the sound signal, the pose, especially absolute or relative pose, is determined.

Preferably, the first camera data and/or the second camera data are collected for a time interval, wherein the time intervals are preferably longer than 10 seconds and especially longer than 1 minute. Furthermore, the first and the second event are an event lasting a or the time interval. Taking the camera data for the time interval and/or using an event which lasts for a time interval the accuracy of the determined poses is increased. Alternatively and/or additionally, the first event and/or the second event are based on different objects, phenomena, physical processes, mechanical processes, chemical processes and/or causal relations. Furthermore, the first and/or second event may comprise sub-events. Using the method with first and second events that are based on different phenomena, objects or causal relations the precision and performance of determining the pose is increased.

Preferably, the determination of the pose, the analyses of the events and/or signals, the processing of camera data and/or the whole performance of the method is carried out using our neural network and/or using machine-learning algorithms. For example, the usage and/or adaption of causal relations for the pose determination is using the neural network and/or machine-learning algorithm.

The invention also concerns a computer program, wherein the computer program is executable on a computer, processor, camera and/or multi-camera system. The computer program is configured to execute the method for determining the camera pose in the multi-camera system when the computer program is run on the computer, processor, camera or multi-camera system.

A further subject matter of invention concerns a machine-readable medium, wherein the medium comprises the computer program. The computer program is especially stored on the medium.

A further subject matter of invention concerns a control unit for the multi-camera system. The control unit is connectable with the multi-camera system, especially the first and/or the second camera. The first and the second camera data, and especially the causal relation between the first and the second event, is provided to the control unit. Especially, the control unit is comprised by the first and/or second camera. The control unit is configured to run and/or execute the method for determining the camera pose. The control unit is especially configured to determine based on the first camera data for the first event and the second camera data for the second event together with the causal relation the relative pose between the first camera and the second camera. Optionally the control unit and/or the method is configured to determine the relative pose and/or absolute pose based on the first camera data for the first event and the second camera data for the second event without a provided causal relation, wherein for example the causal relation is determined by the control unit, the method and/or neural network based on analyzing the first and second camera data for possible causal relations. For example the first and the second camera data are showing a person moving with constant velocity in a fixed direction, the control unit and/or method may use mashing learning or a look up data to choose “moving object and trajectory” as reasonable causal relation for determining the pose.

### BRIEF DESCRIPTION OF THE DRAWINGS

Further features, advantages and effects of the invention will become apparent by the description of preferred embodiments of the invention and the figures as attached. The figures show:

FIG. 1 a schematic side view of a multi-camera system;

FIG. 2 top view on the multi-camera system from FIG. 1.

### DETAILED DESCRIPTION

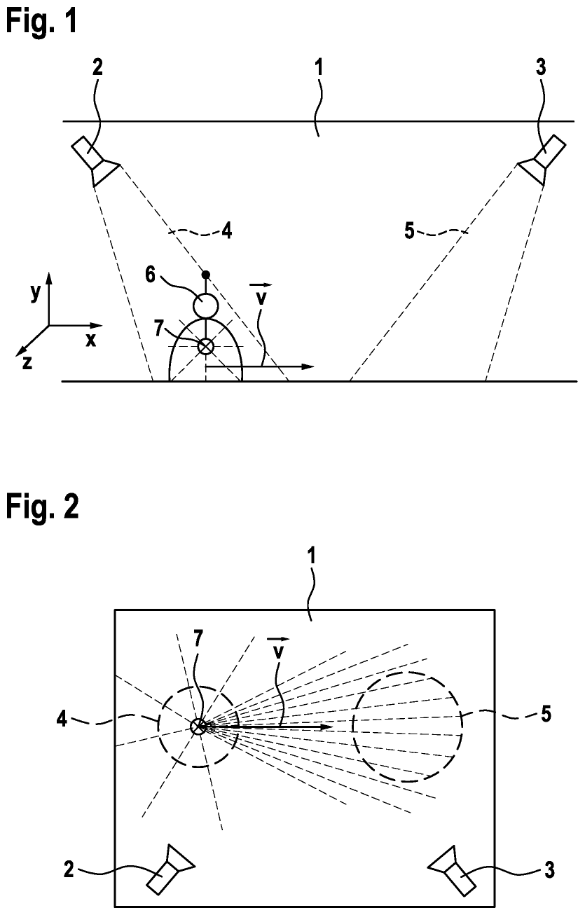

FIG. 1 shows an example of a surveillance area 1, whereby the surveillance area 1 is monitored by a camera system comprising a plurality of cameras, especially a first camera 2 and a second camera 3. The surveillance area 1 is for example an indoor area, like an office building. The surveillance area 1 defines a cartesian world coordinate system with a horizontal axis x a vertical axis y and third perpendicular axis z. In the surveillance area 1 a person and/or objects are basically free in their movement.

The first camera 2 has the first field of view 4 which is basically given by the optics of the first camera 2. The detection area of the first camera 2 is basically given by the field of view 4. Also the second camera 3 has a field of view which is called the second field of view 5. The second field of view 5 sets the detection area of the camera 3. The first camera 2 is adapted to capture images and/or video streams of the field of view 4, wherein the second camera 3 is adapted to capture images and/or video streams of the second field of view 5.

For using the method to determine the camera pose of the first camera 2 and/or the second camera 3, preferably using the world coordinate system xyz, the camera data for a first event and a second event have to be collected. The first event and the second event in this example are based and/or related to a robot 6 which is movable in the surveillance area 1. The robot 6 is configured to follow a trajectory, which is given by the velocity v. Furthermore, the robot 6 comprises a lamp 7, whereby the lamp 7 is configured to send out an modulated light signal, for example with modulated light intensity. The camera 2 is collecting first camera data for the first event, where the first event is given by the presence of the robot 6 in the first field of view 4 as a visible and moving object. The first camera data comprise the robot 6 as its optical presence, its velocity (amount and direction) of the robot 6 and the modulated light generated by the lamp 7. So the first event comprises in other words sup-events, that are to say the modulated light signal, the physical presence and movement of the robot 6.

The second camera 3 is configured to take second camera data for the second event, whereby the second event is directly related to the robot 6 and therefore to the first event. The second event comprises the detection of the modulated light produced by the lamp 7. Furthermore, the second event comprises the detection of the robot 6 at a later time when the robot 6 is entering the field of view 5 of the second camera 3. Preferably, the velocity and trajectory of the robot 6 are also determined when the robot 6 is in the field of view 5. By knowing or determining the velocity v of the robot 6 at first in the first field of view 4 and then in the second field of view 5 the pose of the camera 2 and/or 3 are determined. Furthermore, detecting the modulated light produced by the lamps 7 in the field of view 4 and in the field of view 5 and knowing the speed of light and/or the lightening characteristic of the lamp 7, the pose of the camera 2,3 are determined. To determine the pose more precisely events and data for the movement and light signal are used together.

FIG. 2 shows the surveillance area 1 of FIG. 1 in a top view. In the top view one can see the lightening characteristic of the lamp 7 which is in this embodiment very strong in the direction parallel the velocity v. Using the speed of light and the lightening characteristic of the lamp 7 the relative and/or absolute pose of the camera 2, 3 are determined.

1. A method for determining a camera pose in a multicamera system,
wherein the multicamera system comprises a first camera (2) with a first field of view (4) and a second camera (3) with a second field of view (5), the method comprising:
arranging the first camera (2) and the second camera (3) without an overlap of the first field of view (4) and the second field of view (5),
collecting first camera data for a first event in the first field of view (4), and
collecting second camera data for a second event in the second field of view (5),
wherein the second event is a causal event induced by the first event,
wherein a relative camera pose between the first camera (2) and the second camera (3) is determined based on the first camera data for the first event, the second camera data for the second event and at least one causal relation between the first event and the second event.

2. The method according to claim 1, wherein based on the relative camera pose an absolute pose of the first and/or the second camera (2, 3) is determined.

3. The method according to claim 1, wherein the pose comprises a location and an orientation in space.

4. The method according to claim 1, wherein the first event is based on a moving object (6) in the first field of view (4) and the second event is based on the same object moving (6) in the second field of view (5) at a different time.

5. The method according to claim 4, wherein based on the first camera data a trajectory for the moving object (6) is extrapolated, wherein based on the second camera data the object (6) of the first event is detected in the second field of view (5), wherein based on the detected object (6) in the second field of view (5) and the extrapolated trajectory of the object (6) the pose is determined.

6. The method according to claim 1, wherein the first event is based on a visible object (6) in the first field of view (4), wherein the second event is based on shadowing in the second field of view (5) caused by the visible object (6).

7. The method according to claim 1, wherein the first event is based on a visible object (6) in the first field of view (4), wherein the second event is based on reflection of the visible object (6) in the second field of view (5).

8. The method according to claim 1, wherein the first event is based on a visible object (6) in the first field of view (4), wherein on the visible object a lamb (7) is attached, wherein the second event is based on an illumination pattern in the second field of view (5) caused by the lamb (7) on the visible object (6).

9. The method according to claim 1, wherein the first event is based on a modulated light signal in the first field of view (4), wherein the second event is based on the modulated light signal in the second field of view (5), wherein based on the first camera data and the second camera data the amplitude and/or phase of the light signal is analysed, wherein the pose is determined based on the amplitude and/or phase of the light signal.

10. The method according to claim 1, wherein the first event and the second event are based on a modulated sound signal, wherein the sound signal in the first field of view (4) is captured by first camera (2) and comprised by the first camera data, wherein the sound signal in the second field of view (5) is captured by second camera (3) and comprised by the second camera data, wherein based on the first and the second camera data the amplitude and/or phase of the sound signal is determined, wherein the pose is determined based on the phases and/or amplitude of the sound signal.

11. The method according to claim 1, wherein first camera data and the second camera data are collected for a time interval larger than 1 min and/or for a plurality of first events.

12. The method according to claim 1, wherein the relative camera pose is determined based on the first camera data and the second camera data using a neural network.

13. (canceled)

14. A non-transitory machine-readable readable medium containing instructions that when executed by a computer cause the computer to determining a camera pose in a multicamera system, wherein the multicamera system comprises a first camera (2) with a first field of view (4) and a second camera (3) with a second field of view (5), and the first camera (2) and the second camera (3) are arranged without an overlap of the first field of view (4) and the second field of view (5), by
collecting first camera data for a first event in the first field of view (4), and
collecting second camera data for a second event in the second field of view (5),
wherein the second event is a causal event induced by the first event,
wherein a relative camera pose between the first camera (2) and the second camera (3) is determined based on the first camera data for the first event, the second camera data for the second event and at least one causal relation between the first event and the second event.

15. A control unit for a multicamera system with a first camera (2) and a second camera (3), especially configured for performing the method according to claim 1, wherein the control unit is connected with the multicamera system, wherein first camera data taken with the first camera (2) for a first event and second camera data taken with the second camera (3) for a second event are provided to the control unit, wherein the second event is causal related to and induced by the first event, wherein the control unit is configured to determine a relative pose of the first and second camera based on the first camera data and the second camera data.
